(19) United States
(12) Patent Application Publication
(10) Pub. No.: US 2012/0055687 A1
(43) Pub. Date: Mar. 8, 2012

(54) BATTERY OPERATED PORTABLE TOOLS

(75) Inventor: Pär Martinsson, Jonkoping (SE)

(73) Assignee: HUSQVARNA AB, Huskvarna (SE)

(21) Appl. No.: 13/265,885

(22) PCT Filed: Apr. 24, 2009
(86) PCT No.: PCT/EP2009/002999

§ 371 Date: Oct. 24, 2011

(51) Int. Cl. B25F 5/02; B25F 5/00

(52) U.S. Cl. 173/20; 173/217

(57) ABSTRACT

A battery-operated portable tool (1), comprising a housing (2), a battery pack (3) comprising a battery pack housing (3) supporting a battery (10), a mounting (16) releasably and replaceably mounting the battery pack (3) on the housing (2), a motor (4) in the housing (2) arranged to be driven by the battery (10) in order to operate the tool (1) and a control circuit (7) arranged to control the application of current from the battery (10) to the motor (4), in which the mounting (16) has a active position where the battery pack (3) is held against the housing (2) and the battery (10) is in electrical contact with the control circuit (7), an open position when the mounting (16) does not hold the battery pack (3) against the housing (2) such that the battery pack (3) can be removed from the housing (2) and an inactive position where the mounting (16) holds the battery pack (3) against the housing (2) but the battery (10) is not in electrical contact with the control circuit (7).

This invention relates to battery-operated portable tools.

Battery-powered portable tools, such as handheld drills, chainsaws, hedge trimmers and so on, generally comprise a housing supporting a battery, a motor and a driven element, such as a blade or a chuck holding a drill bit. The battery powers the motor, which in turns drives the driven element.

It is desirable to attempt to ensure that the tool activates only when desired; otherwise, a user could be surprised by an inadvertent activation of the tool, particularly if that user is inexperienced in the use of such tools. This is particularly the case with such tools where the battery is provided in a removable pack; replacing the pack could lead to inadvertent operation. With petrol- or gasoline-powered portable tools, it is obvious when such tools are potentially active, as the engine that powers those tools makes noise when idle. A battery-powered tool, on the other hand, makes no noise when idle.

According to a first aspect of the invention, there is provided a battery-operated portable tool, comprising a housing, a battery pack comprising a battery pack housing supporting a battery, a mounting releasably and replaceably mounting the battery pack on the housing, a motor in the housing arranged to be driven by the battery in order to operate the tool and a control circuit arranged to control the application of current from the battery to the motor, in which the mounting has a active position where the battery pack is held against the housing and the battery is in electrical contact with the control circuit, an open position when the mounting does not hold the battery pack against the housing such that the battery pack can be removed from the housing and an inactive position where the mounting holds the battery pack against the housing but the battery is not in electrical contact with the control circuit.

As such, this provides for an inactive position where the battery pack is held securely on the housing but cannot drive the motor, because it is not in electrical contact with the control circuit. Thus, the user can place the mounting in the inactive position to ensure that the tool does not inadvertently activate, thus preventing the user being surprised; the battery pack is, however, secure.

Typically, in the inactive position, the mounting will physically separate the battery pack from the housing, whilst still supporting the battery pack relative to the housing. The mounting may fix the battery pack relative to the housing, whilst spacing it from the housing. In one embodiment, the battery pack comprises battery contacts in electrical contact with the battery, and the housing comprises corresponding input contacts in electrical contact with the control circuit, and the mounting in the inactive position holds the battery pack such that the battery contacts do not make contact with the input contacts, whilst in the active position the mounting holds the battery pack relative to the housing such that the battery contacts and the input contacts are in physical contact.

As such, to switch the active and inactive states, the mounting may be arranged to move the battery pack relative to the housing. Alternatively, the mounting may be arranged to move the input contacts relative to the battery pack.

The mounting may comprise a lever, which can be manipulated by a user to transfer the mounting from the active position to the inactive position by forcing the battery pack and the housing apart. This is useful where spring-loaded contacts are employed, as the force required to separate them can be quite large. As such, the lever may comprise a handle graspable by a user and pivotally mounted about a pivot point on one of the battery pack and the housing; the lever may further comprise a cam surface of variable radius relative to the pivot point, which acts on the other of the battery pack and the housing. This is a very intuitive solution to the problem of disengaging the battery pack from the housing, and avoids repeated disengagement of the battery pack to the inactive position of the mounting tiring a user unduly.

The mounting may comprise a clip holding the battery pack against the housing, the clip engaging two detents in one of the battery pack and the housing, one detent defining the inactive position and another the active position. The detents may be notches in the battery pack or the housing.

In addition to holding the battery pack relative to the housing in the inactive position and in the active position, the mounting may comprise a switch that electrically isolates the battery from the control circuit in the inactive position but not the active position.

An indicator may be provided which provides an indication, when the battery pack is mounted relative to the housing, of whether the mounting is in the active or inactive state. For example, this may be a light which illuminates in the active state, or an indicium carried on an indicating member, the position of which provides the indication; the indicating member may be partially concealed behind a window in the housing or in the battery pack housing, the part of the indicating member providing the indication.

The tool may be a drill, hedge trimmer, chainsaw, sander or any other power tool that can be operated by a removable, replaceable battery.

There now follows, by way of example only, embodiments of the invention, described with reference to the accompanying drawings, in which:

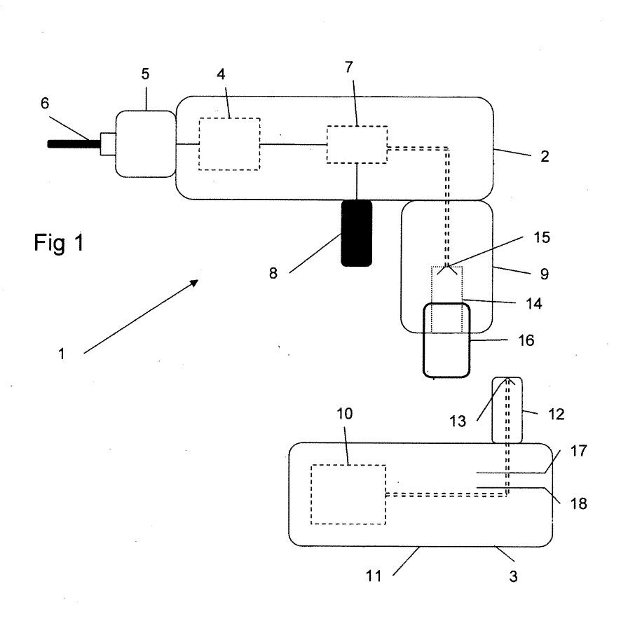

FIG. 1 shows a drill according to a first embodiment of the invention, with its battery pack disconnected and the mounting in the open position;

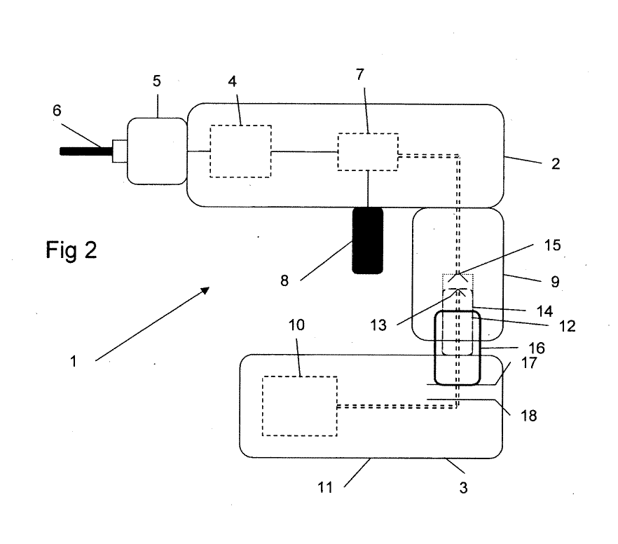

FIG. 2 shows the drill of FIG. 1, with the battery pack mounted on the housing in an inactive position of the mounting;

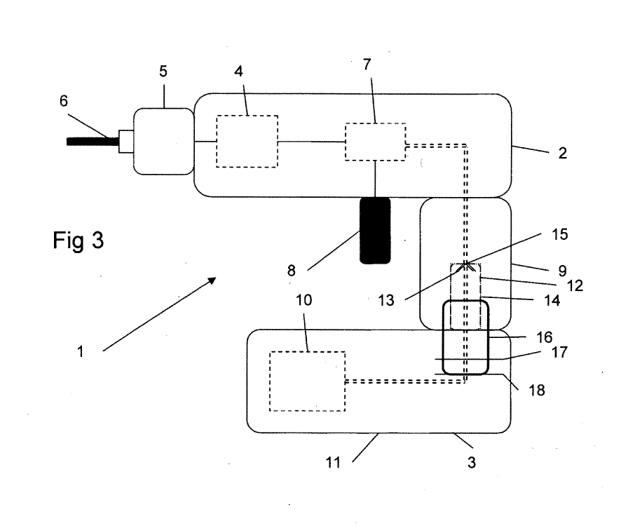

FIG. 3 shows the drill of FIG. 1, with the battery pack fully engaged on the housing with the mounting in an active position;

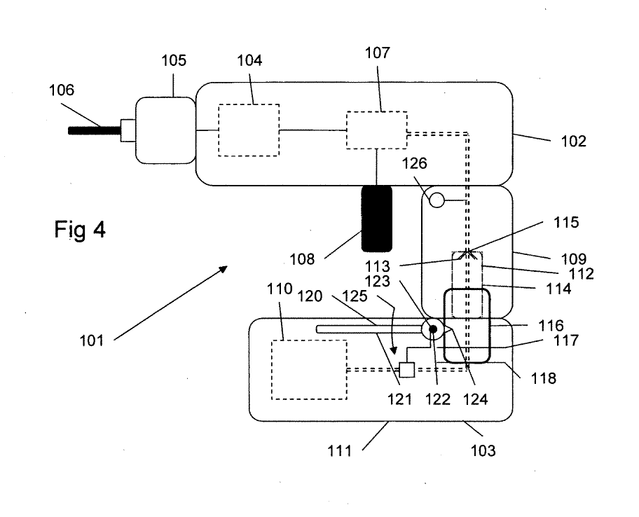

FIG. 4 shows a drill according to a second embodiment of, the invention, in an equivalent view to that of FIG. 3;

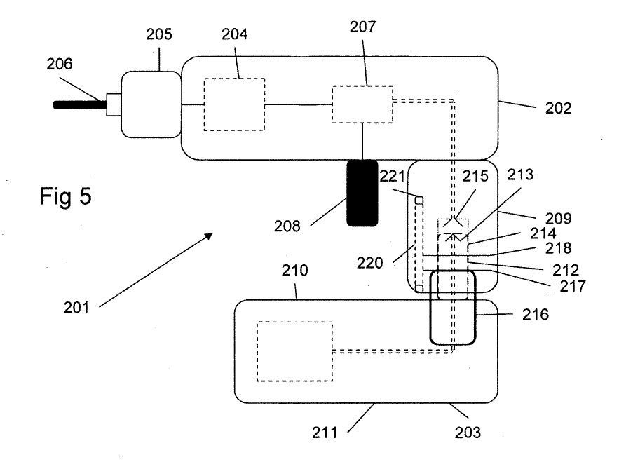

FIG. 5 shows a drill according to a third embodiment of the invention, in an equivalent view to that of FIG. 2;

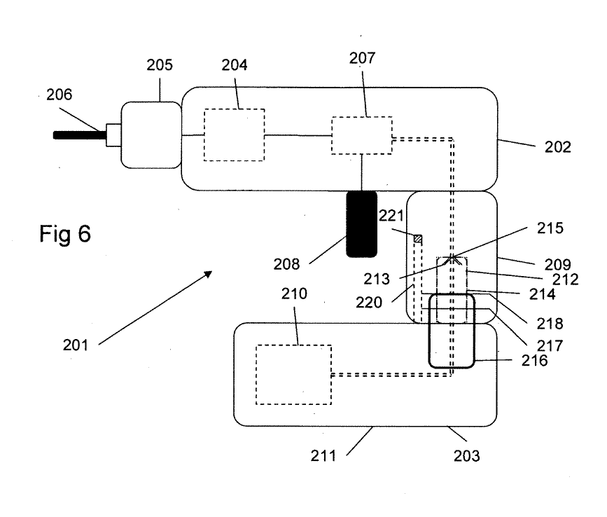

FIG. 6 shows the drill of FIG. 5 in an equivalent view to that of FIG. 3;

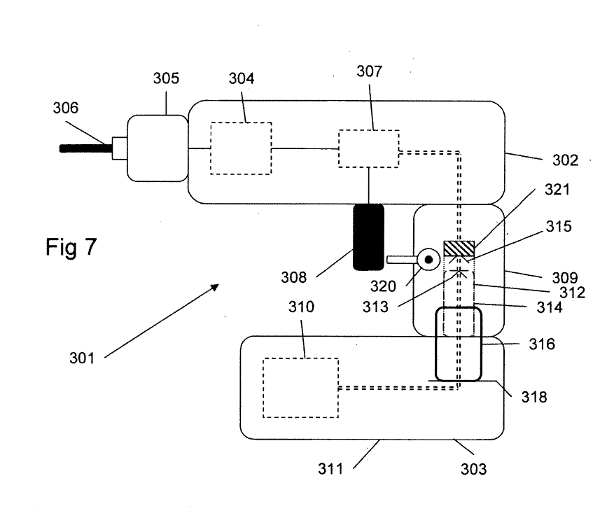

FIG. 7 shows a drill according to a fourth embodiment of the invention, in an equivalent view to that of FIG. 2; and

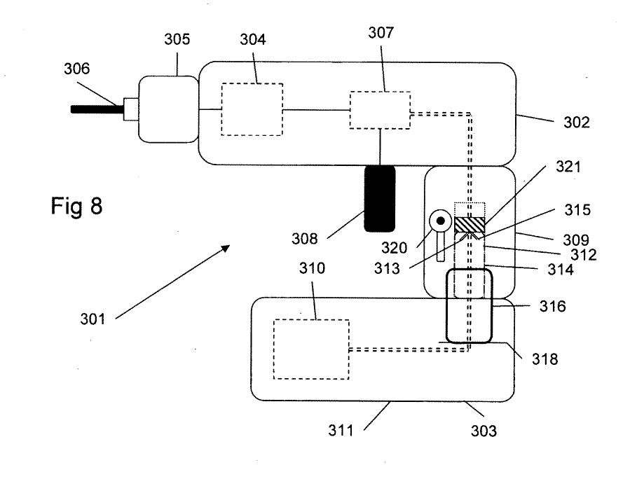

FIG. 8 shows the drill of FIG. 7 in an equivalent view to that of FIG. 3.

A battery powered portable drill 1 is shown in the accompanying drawings. It comprises a housing 2 and a removable, replaceable battery pack 3. The drill 1 further comprises a motor 4 in the housing, which can drive a chuck 5 carrying a bit 6 to rotate, so that the user can use the drill 1 to make holes in a substrate.

The application of current to the motor is controlled by a control circuit 7. This can be a simple switch, or variable resistor, or any other device that varies the current supplied to the motor dependent upon the position of a trigger 8. Thus, the user can manipulate the trigger—typically, by squeezing the trigger against a handle 9 being part of the housing—in order to activate the drill and potentially control the speed at which the bit is rotated.

In order to provide the current that drives the motor 4, a battery 10 is provided in the battery pack 3. The battery pack 3 comprises a battery pack housing 11 within which is mounted the battery 10. An extension 12 of the battery pack housing 11 extends away from the remainder of the battery pack housing 11, and carries on its distal end two battery contacts 13 in electrical contact with the battery (being connected to the battery by means of the electrical connection shown as doubled dotted lines in the Figures).

This extension is received within a correspondingly-shaped bore 14 within the handle 9. Corresponding electrical input contacts 15 are electrically connected to the control circuit 7, such that when the extension 12 is fully received within the bore, the battery contacts 13 of the battery pack are in physical and electrical contact with the input contacts 15. Thus, in such a case, the battery 10 is in electrical contact with the control circuit 7 through the battery contacts 13 and the input contacts 15.

The drill 1 is further provided with a mounting 16 of the form of a spring loaded metal clip mounted on the handle 9. This can engage either of two grooves 17, 18 in the battery pack housing 11. As such, this gives rise to three positions of the mounting as described below.

In the open position shown in FIG. 1 of the accompanying drawings, the battery pack 3 is disconnected from the housing 2 and the mounting 16 does not engage the battery pack at all. This is the case where the battery pack 3 has been removed for replacement, recharging or storage.

In the inactive position shown in FIG. 2 of the accompanying drawings, the mounting engages the upper groove 17. The battery pack 3 is therefore secured against movement relative to the housing. However, the mounting 16 holds the battery pack 3 in a position where the extension 12 is within the bore 14, but is not fully inserted. As such, the battery contacts 13 do not make contact with the input contacts 15, and the battery is electrically isolated from the control circuit 7 by the gap between the contacts 13, 15. A user cannot be surprised by the drill operating should the trigger 8 be inadvertently activated, because current cannot be supplied to the motor 4.

In the active position shown in FIG. 3 of the accompanying drawings, the mounting 16 engages the lower groove 18. The extension is now fully engaged in the bore, and the battery contacts 13 are in physical and electrical contact with the input contacts 15. The battery is securely held against the housing. Thus, the battery 10 is in electrical contact with the control circuit 7, which can therefore supply current to the motor 4 on activation of the trigger.

Accordingly, it can be seen that this embodiment provides a drill (although there is no reason why the teachings of this embodiment could not be applied to any other battery operated power tool) in which a user can select whether the battery 10 is electrically connected to the control circuit 7 and hence the motor 4. In the active position, the battery 10 can provide current to drive the motor 4, whereas in the inactive position it cannot. In both cases the battery is held securely, and so the user can transport the drill with ease. Furthermore, it will be obvious to the user which position the mounting is in; they can see which groove 17, 18 the mounting 16 is in and see whether there is a gap between the battery housing 11 and the handle 9. Thus, a user can know whether the drill is liable to be active.

In order to assist the user with moving the mounting 16 from the active to the inactive states, a lever may be provided as shown in the second embodiment of the invention shown in FIG. 4. Where the same features are present in the first embodiment, they are represented in the present embodiment by the same reference numeral, raised by 100.

As such, the main functioning of the drill 101 is the same as previously, and reference is made to the discussion above. However, the mounting, in addition to the spring loaded clip 116 also comprises a lever 120. This lever 120 comprises an elongate handle portion 121, pivoted on the battery pack housing 111 at a pivot point 122. The head 123 of the lever 120 provides a cam, with a generally circular surface having a protrusion 124.

As such, in normal use, the handle portion 121 lies flat against the battery pack 103. Should the user desire to move the mounting from the active to inactive states, the user rotates the lever 120 in the direction shown by arrow 125. Thus, the head 123 of the lever will rotate, bringing the protrusion 124 into contact with the housing 102 at the bottom of the handle 109. Continued rotation will drive the protrusion against the handle 109, thus separating the battery pack 103 and the housing 102, until the clip 116 engages the upper groove 117 thus placing the mounting in the inactive position. This makes the action of placing the mounting in the inactive position easier for the user.

In addition, the lever 120 also acts as a switch. When the lever is rotated in the direction 125, the lever 120 electrically disconnects the battery 110 from the battery contacts 113. Thus, the lever 120 disconnects the battery 110 from the control circuit 107 both electrically and physically.

Furthermore, it is desirable for there to be an indication to the user of whether the device is active. This could be achieved by positioning a light emitting device, such as a Light Emitting Diode across the electrical connection between the input contacts 115 and the control circuit 107, as shown as LED 126. This will then light up whenever the battery pack 103 is connected in the active position, assuming the battery 110 is charged; this therefore provides a warning to the user that the drill 101 could be active. In an alternative, this LED could be provided on the battery pack, but would still indicate when a closed circuit to the control circuit 107 is provided. Furthermore, rather than simply lighting up when the drill is active, the LED could change colour, possibly from red indicating inactive, to green indicating active.

In a third embodiment of the invention, shown in FIGS. 5 and 6 of the accompanying drawings, an alternative indicator is provided that does not depend upon current being provided from the battery. Again, where the same features are present in the first embodiment, they are represented in the present embodiment by the same reference numeral, raised by 200. The indication is provided by a rod 220 working in a bore in the handle 209. The rod is spring-loaded, such that if the battery pack 3 is not fully engaged (such as in the inactive position of the mounting as shown in FIG. 5), the end of the rod protrudes from the housing 202 at the end of the handle 209. A window 221 is provided at the other end of the bore; when the battery pack is not engaged, the rod will not be visible through the window.

Once the battery pack 203 is fully engaged (such as in the active position of the mounting shown in FIG. 6), the battery pack housing 211 will force the rod into the bore, such that the end of the rod 220 is now visible through the window 221, as depicted by the hatching in FIG. 6. The end of the rod 220 can be a bright colour such a striking red, which will provide a user with a warning that the device could be active.

Furthermore, in this embodiment the mounting 216 is pivotally mounted on the battery pack housing 211. The grooves 217, 218 are therefore on the handle 209.

In a fourth embodiment of the invention, shown in FIGS. 7 and 8 of the accompanying drawings, the mounting includes a moveable set of input contacts 315. Again, where the same features are present in the first embodiment, they are represented in the present embodiment by the same reference numeral, raised by 300.

In this embodiment, the bore 314 extends further into the handle 309 than the length of the extension 312. A carrier 321 carrying the input contacts 315 is provided, which can move along the blind end of the bore 314. This is driven by a lever 320, which can be turned by a user to move the contacts relative to the housing 302. The drive can be of the form of a geared pinion of an axle turned by the level 320 engaging a rack formed on the adjacent edge of the carrier 321.

In the present embodiment, the battery pack 203 itself has only one installed position relative to the housing 302: fully engaged. However, in the inactive state shown in FIG. 7 of the accompanying drawings, the carrier 321 and the input contacts 315 are fully withdrawn to the end of the bore 314. This means that, despite the battery pack 302 is mounted with the extension 312 fully engaging the bore 314, the input contacts 315 do not contact the battery contacts 313. The battery 310 is therefore not in electrical contact with the control circuit 307.

In the active state shown in FIG. 8 of the accompanying drawings, the lever 320 has been rotated to drive the carrier 321 and hence the input contacts 315 towards, and into contact with the battery contacts 313.

Accordingly, the battery is now in electrical contact with the control circuit 307.

1. A battery-operated portable tool, comprising a housing, a battery pack comprising a battery pack housing supporting a battery, a mounting releasably and replaceably mounting the battery pack on the housing, a motor in the housing arranged to be driven by the battery in order to operate the tool and a control circuit arranged to control the application of current from the battery to the motor, in which, the mounting has a active position where the battery pack is held against the housing and the battery is in electrical contact with the control circuit, an open position when the mounting does not hold the battery pack against the housing such that the battery pack is removable from the housing and an inactive position where the mounting holds the battery pack against the housing but the battery is not in electrical contact with the control circuit,
wherein, in the inactive position, the mounting physically separates the battery pack from the housing, whilst still supporting the battery pack relative to the housing.

2. (canceled)

3. The tool of claim 1, in which the battery pack comprises battery contacts in electrical contact with the battery, and the housing comprises corresponding input contacts in electrical contact with the control circuit, and the mounting in the inactive position holds the battery pack such that the battery contacts do not make contact with the input contacts, whilst in the active position the mounting holds the battery pack relative to the housing such that the battery contacts and the input contacts are in physical contact.

4. The tool of claim 1, in which to switch between the active and inactive states, the mounting is arranged to move the battery pack relative to the housing.

5. A battery-operated portable tool, comprising a housing, a battery pack comprising a battery pack housing supporting a battery, a mounting releasably and replaceably mounting the battery pack on the housing, a motor in the housing arranged to be driven by the battery in order to operate the tool and a control circuit arranged to control the application of current from the battery to the motor, in which, the mounting has a active position where the battery pack is held against the housing and the battery is in electrical contact with the control circuit, an open position when the mounting does not hold the battery pack against the housing such that the battery pack is removable from the housing and an inactive position where the mounting holds the battery pack against the housing but the battery is not in electrical contact with the control circuit, wherein the battery pack comprises battery contacts in electrical contact with the battery, and the housing comprises corresponding input contacts in electrical contact with the control circuit, in which in order to switch between the active and inactive states, the mounting is arranged to move the input contacts relative to the battery pack while holding the battery pack in a fixed position relative to the housing.

6. The tool of claim 1, in which the mounting comprises a lever, which is manipulatable by a user to transfer the mounting from the active position to the inactive position by forcing the battery pack and the housing apart.

7. The tool of claim 1, in which the mounting comprises a clip holding the battery pack against the housing, the clip engaging two detents in one of the battery pack and the housing, one detent defining the inactive position and another the active position.

8. A battery-operated portable tool, comprising a housing, a battery pack comprising a battery pack housing supporting a battery, a mounting releasably and replaceably mounting the battery pack on the housing, a motor in the housing arranged to be driven by the battery in order to operate the tool and a control circuit arranged to control the application of current from the battery to the motor, in which, the mounting has a active position where the battery pack is held against the housing and the battery is in electrical contact with the control circuit, an open position when the mounting does not hold the battery pack against the housing such that the battery pack is removable from the housing and an inactive position where the mounting holds the battery pack against the housing but the battery is not in electrical contact with the control circuit, in which, in addition to holding the battery pack relative to the housing in the inactive position and in the active position, the mounting may comprises a switch that electrically isolates the battery from the control circuit in the inactive position but not the active position.

9. The tool of claim 1, comprising an indicator which provides an indication, when the battery pack is mounted relative to the housing, of whether the mounting is in the active or inactive state.

10. The tool of claim 1, wherein the tool is a drill, hedge trimmer, chainsaw, sander or power tool operable by a removable, replaceable battery.
